(19) United States
(12) Patent Application Publication
(10) Pub. No.: US 2023/0096229 A1
(43) Pub. Date: Mar. 30, 2023

(54) TELESCOPING STICK FOR TESTING EMERGENCY SAFETY SYSTEMS

(71) Applicant: Fausto Gil, Apex, NC (US)

(72) Inventor: Fausto Gil, Apex, NC (US)

(21) Appl. No.: 17/484,748

(22) Filed: Sep. 24, 2021

(51) Int. Cl. F16B 7/10; B25J 1/04

(52) U.S. Cl. CPC F16B 7/105; B25J 1/04

(57) ABSTRACT

An improved telescoping stick for testing emergency safety systems is disclosed. The telescoping stick retracts so that the user can easily carry the stick throughout a commercial building without inconveniencing the people in the building, and it extends so that the user can easily reach test or reset buttons on emergency devices, such as emergency lights and exit signs. The end of the improved telescoping stick includes a rotatable tip on a ball-and-socket swivel that allows the tip to be orientated in any direction to reach a button of any configuration.

### TECHNICAL FIELD

The present invention relates to testing emergency safety systems, and specifically to an improved telescoping stick for testing emergency safety systems.

### BACKGROUND

Emergency lights and exit signs are critical safety equipment in commercial buildings. According to various building codes, these emergency lights and exit signs must be tested regularly to ensure they are operating correctly. They also must be reset occasionally. These regular tests and/or resets include pressing a “test” or “reset” button located on the lights or signs. In large buildings where there are numerous emergency lights and exit signs, the process of testing them all can be very time consuming, especially when they are mounted high on the wall or ceiling, out of normal reach of the person testing them. Carrying a ladder throughout the building and setting up the ladder at each emergency light or exit sign is both time consuming and burdensome.

U.S. Design Pat. No. D711,706, issued Aug. 26, 2014, to Earl Votolato shows a design of a telescoping reset/testing tool with interchangeable heads. The design of the telescoping reset/testing tool shown in D711,706 includes a round telescoping stick with multiple interchangeable heads that are each of a fixed “Y” or “T” shape. The design shown in D711,706 is an inefficient solution.

It would be beneficial to have an improved telescoping stick for testing emergency safety systems.

### SUMMARY

Accordingly, described herein is an improved telescoping stick for testing emergency safety systems.

This summary is provided to introduce in a simplified form concepts that are further described in the following detailed descriptions. This summary is not intended to identify key features or essential features of the claimed subject matter, nor is it to be construed as limiting the scope of the claimed subject matter.

The present disclosure describes implementations that relate to an improved telescoping stick for testing emergency safety systems. The improved telescoping stick described herein retracts so that it can be easily stored and so that the user can easily carry the stick throughout a commercial building without inconveniencing the people in the building (unlike, for example, a ladder), and it extends so that the user can easily reach test or reset buttons on emergency devices, such as emergency lights and exit signs, for example. The end of the improved telescoping stick described herein includes a rotatable tip mounted on a ball-and-socket swivel that allows the tip to be orientated in almost any direction to reach a button of any configuration.

The improved telescoping stick described herein provides numerous advantages over the prior-art stick shown in USPN D711,706. First, for example, the tip of the improved telescoping stick described herein rotates to almost any angle, which provides an advantage because, as explained in more detail below, it can cover all possible angles, whereas the angles covered by the prior-art stick are fixed and require a swap of the interchangeable heads to change the position, which requires that the user have the additional interchangeable heads with them at all times. Second, for example, the tip of the improved telescoping stick described herein does not twist or retract as the user applies force to the button, which provides an advantage over the prior-art stick because the prior-art stick has a circular cross-section that allows it to rotate and because it lacks any locking elements that prevents it from retracting while trying to press the button.

### BRIEF DESCRIPTION OF THE DRAWINGS

In order to more clearly describe the technical solutions of the examples of the telescoping stick described herein, the figures required to be used for the examples will be briefly introduced below. It should be understood that the following figures only show some examples, and thus shall not be construed as limiting the scope of the disclosed telescoping stick; and for a person skilled in the art, further relevant figures could also be obtained according to the figures without using inventive efforts.

FIG. 1 depicts the improved telescoping stick for testing emergency safety systems in use.

FIG. 2 depicts a perspective view of the improved telescoping stick for testing emergency safety systems in an extended position.

FIG. 3 depicts a perspective view of the improved telescoping stick for testing emergency safety systems in a retracted position.

FIG. 4 depicts a perspective view of the rotating head of the improved telescoping stick for testing emergency safety systems.

### DETAILED DESCRIPTION OF THE EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Embodiments of the presently disclosed subject matter provide for an improved telescoping stick for testing emergency safety systems.

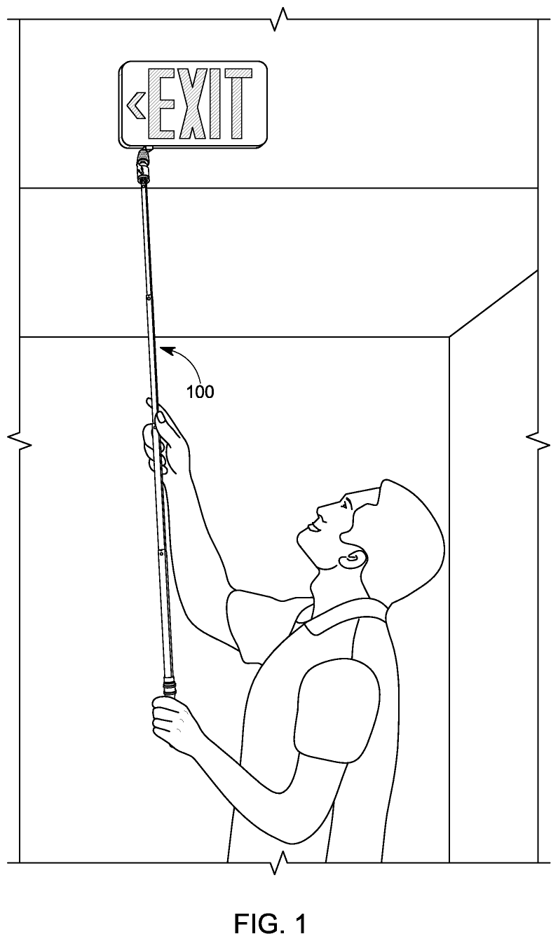

FIG. 1 depicts the improved telescoping stick for testing emergency safety systems in use.

Referring to FIG. 1, a telescoping stick 100 is used for pressing a button on an emergency device such as an exit sign, an emergency light, smoke detector, fire alarm, or the like. The emergency device may be mounted at a height such that it is generally out of reach of the general public, at least without the use of a ladder or other propping device. The emergency device may be mounted, for example, on the ceiling, on a wall near the ceiling, or on pieces that are connected to the ceiling, such as rafters, beams, pipes, or the like. In most instances, the emergency device is mounted at a height of anywhere from 7 feet to 12 feet, although it will be understood that they may be mounted at different heights in different contexts.

The button being pressed may be a “test” or a “reset” button, or it may be any other type of button that needs to be quickly and efficiently accessed but is just out of reach without a ladder or other similar device.

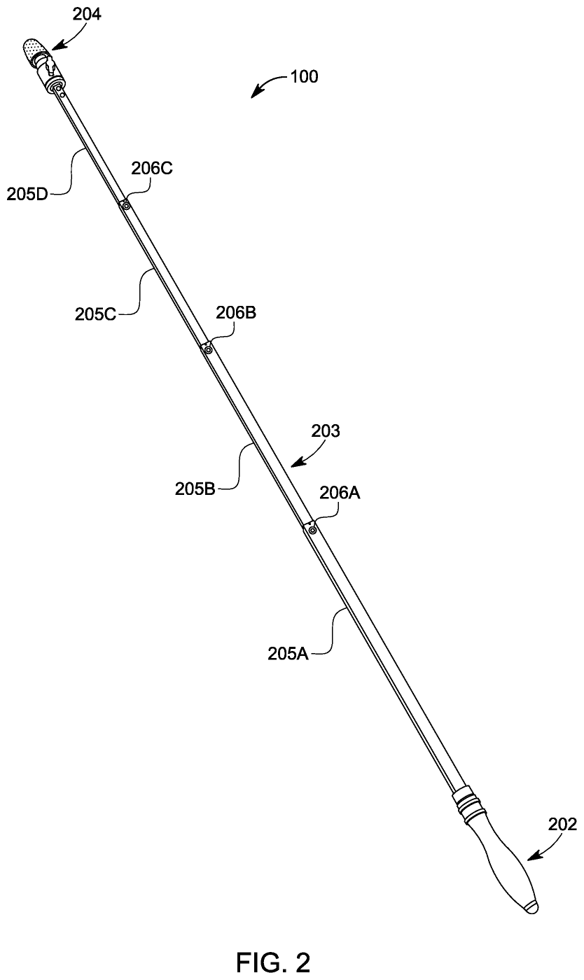

FIG. 2 depicts a perspective view of the improved telescoping stick for testing emergency safety systems in an extended position.

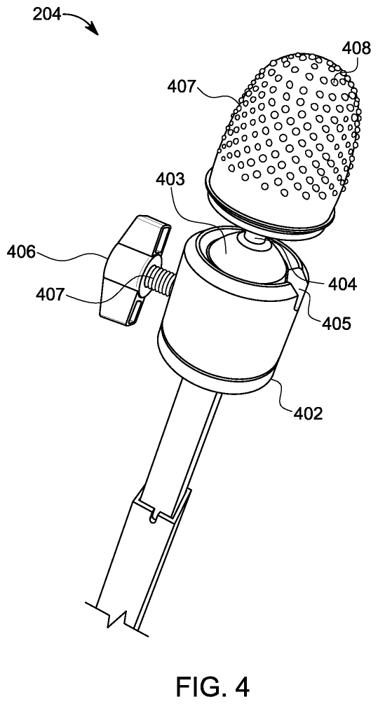

Referring to FIG. 2, the telescoping stick 100 for pressing a button on an emergency device that is mounted at a height comprises three portions. The three portions of the telescoping stick 100 include a handle 202, and extendable portion 203, and a head assembly 204. The handle 202 is located proximate a first end of the telescoping stick 100. The first end of the telescoping stick 100 is the end that is held by the user. The head assembly 204 is located proximate a second end of the stick opposite the first end. The second end of the telescoping stick 100 is the end that presses the button on the emergency device. In other words, the handle 202 and the head assembly 204 are located at or near (collectively “proximate”) opposite ends of the telescoping stick 100. The handle 202 may be any type of handle. The head assembly 204 is described in more detail in the context of FIG. 4.

The extendable portion 203 connects handle 202 to head assembly 204. One end of extendable portion 203 is mechanically coupled to handle 202. The opposite end of extendable portion 203 is mechanically coupled to head assembly 204. The extendable portion 203 comprises multiple tubular sections 205a, 205b, and 205c arranged in a nesting configuration such that the multiple tubular sections extend in a telescoping manner along a longitudinal axis between the first end of the telescoping stick 100 (i.e., where the head assembly is located) and the second end of the telescoping stick 100 (i.e., where the handle is located).

The number of tubular sections may vary depending on the particular use case of the telescoping stick 100. In one embodiment, the telescoping stick 100 includes four tubular sections. In other embodiments, the telescoping stick 100 may include more or fewer tubular sections. The tubular sections may all be the same length, or they may vary in length from one another, with the outer, lower-most tubular section being the longest at each tubular section nested inside that one being incrementally shorter than the previous tubular section. It will be understood that overall length of the telescoping stick 100 when in the retracted position is influenced by the length of the longest tubular section, so a shorter retracted stick will have more sections that are each shorter in length, whereas a longer retracted stick will have fewer sections that are each longer in length.

In one embodiment, the telescoping stick 100 may be approximately seven feet long when fully extended. Having a stick that is seven feet long when fully extended is beneficial because most people's fully extended (unassisted) reach is approximately six to seven feet, so the seven-foot-long stick allows a user to comfortably reach a button as high as 13 or 14 feet, which is higher than the ceilings in most commercial buildings. A telescoping stick 100 that is approximately seven feet long when fully extended may comprise, for example approximately eight inches of handle, approximately four inches of head assembly, and approximately six feet of tubular sections. As mentioned, in one embodiment, there are four tubular sections, with each tubular section being approximately one-and-a-half feet long.

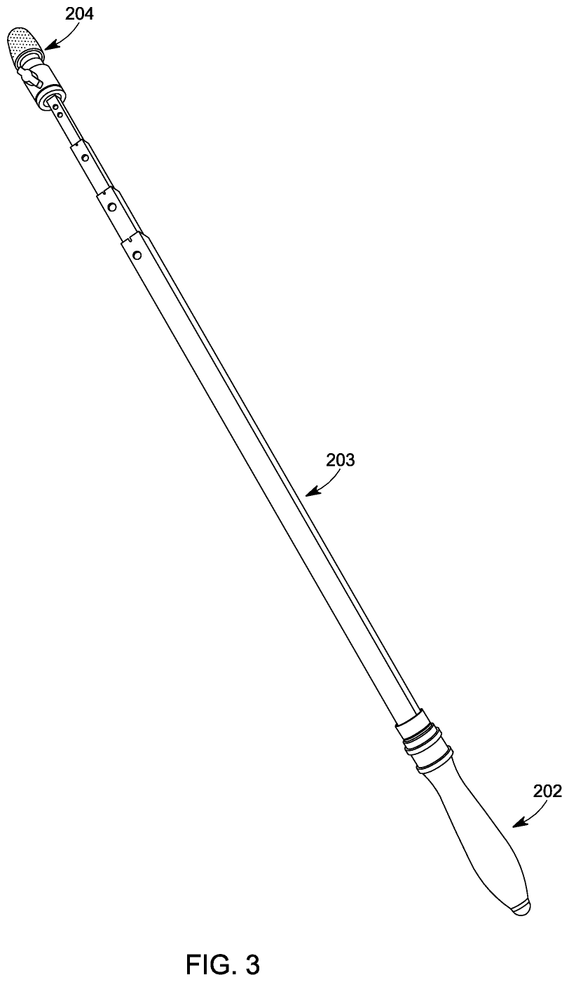

The extendable portion 203 allows for the telescoping stick 100 to include an extended configuration (as shown in FIG. 2) and a retracted configuration (as shown in FIG. 3). In various embodiments, the multiple tubular sections are non-circular in cross-section, which prevents them from spinning or rotating in the user's hand while the user is trying to apply force to the button. For example, the multiple tubular sections may be square in cross-section. This is particularly beneficial in situations where the button is in a tight or hard-to-reach space, or when it is at an awkward angle.

Each tubular section slidably engages at least one adjacent tubular section. For example, the tubular sections at each end (e.g., 205a and 205c shown in FIG. 2) each only engage one adjacent tubular section (e.g., 205b shown in FIG. 2). Similarly, the tubular sections in the middle (e.g., 205b shown in FIG. 2) each engage two adjacent tubular sections (e.g., 205a and 205c shown in FIG. 2). The adjacent tubular section slidably engage one another in that they are sized and shaped so that one tubular section fits inside the adjacent tubular section, providing the telescoping action of the tubular sections.

Each tubular section is releasably locked into place with at least one adjacent tubular section when the telescoping stick 100 is in the extended configuration using cooperating locking means 206a, 206b, and 206c between adjacent tubular sections for restraining movement of the tubular sections relative to one another when engaged. The cooperating locking means may be a spring-loaded button on the inner tubular section and a corresponding aperture on the outer tubular section, as shown, for example, in FIG. 2. In other embodiments, the cooperating locking means may be a force-fit nub and depression, or other well-known engagement means.

FIG. 3 depicts a perspective view of the improved telescoping stick for testing emergency safety systems in a retracted position.

Referring to FIG. 3, the tubular sections 205a-205d are shown nested and retracted into one another in a telescoping manner. As shown in FIG. 3, the cooperating locking means are not engaged when the stick 100 is in the retracted position, which allows for easy extension. The cooperating locking means 206a-206c only engage when the stick 100 is in the fully extended position.

FIG. 4 depicts a perspective view of the rotating head of the improved telescoping stick for testing emergency safety systems.

The head assembly 204 comprises a ball-and-socket swivel and a button-engagement tip for pressing a button on an emergency device. The ball-and-socket swivel comprises a socket 402 with a ball 403 rotatably engaged in the socket. The ball 403 is able to move or rotate within the socket 402 along any axis. The ball-and-socket swivel has a tightening means for releasably fixing the ball-and-socket swivel at a specified position. As shown in FIG. 4, the tightening means is a threaded rod 407 with a knob 406 at a distal end that allows the threaded rod 407 to be tightened into the socket 402 such that the proximate end of the threaded rod 407 bears against ball 403 and prevents ball 403 from moving, thereby fixing it in a specific position. In other embodiments, the tightening means may be any known way of tightening, such as a screw or a lever that provides a clamping force to the socket 402, which fixes the ball 403 in a specified position.

Ball 403 of the ball-and-socket swivel may include a connection 404 extending from the ball 403 to provide for a mechanical coupling of the ball-and-socket swivel to the button-engagement tip 407. The connection 404 may be any type of connection as will be understood by a person having ordinary skill in the art. Such connection 404 may allow for the button-engagement tip 407 to be swapped out with other types of tips.

In some embodiments, as shown in FIG. 4, the walls of the socket 402 may be tall enough such that they surround a majority of the ball 403. In such a situation, the connection 404 may prevent the ball-and-socket swivel from being arranged in a configuration that is perpendicular to the longitudinal axis of the telescoping stick 100. In other words, the connection 404 contacting the walls of socket 402 may prevent the tip from reaching the latitudinal axis of ball 403. For this reason, socket 402 may include a notch 405 that engages with connection 404 to allow the attachment at the end of the ball-and-socket swivel to be oriented perpendicular to the longitudinal axis of the telescoping stick 100, along the latitudinal axis of ball 403.

Because the entire telescoping stick 100 can be rotated in the user's hand, that means that the user is able to set the button-engagement tip 407 at any angle or orientation relative to the telescoping stick 100.

The button-engagement tip 407 may be shaped to approximate the size and shape of a human finger, which allows it to easily press buttons that are meant to be pressed by human fingers. In one embodiment, the button-engagement tip 407 may be made of rubber, silicone, or another tacky material that provides for better engagement of the button. In the embodiment shown in FIG. 4, the button-engagement tip 407 includes multiple nubs 408 for further providing grip on the button being pressed.

The button-engagement tip 407 may be interchangeable for other tips of varying shapes and sizes, as required by the particular application.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains.

Following long-standing patent law convention, the terms “a,” “an,” and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A telescoping stick for pressing a button on an emergency device mounted at a height, the stick comprising:
a handle located proximate a first end of the stick;
a head assembly located proximate a second end of the stick opposite the first end of the stick, the head assembly comprising:
a ball-and-socket swivel having a tightening means for releasably fixing the ball-and-socket swivel at a specified position; and
a button-engagement tip for pressing a button on an emergency device, the button-engagement tip being mechanically coupled to the ball-and-socket swivel such that the button-engagement tip is rotatably mounted at the second end of the stick; and
an extendable portion connecting the handle to the head assembly by being mechanically coupled to the handle at one end thereof and being mechanically coupled to the head assembly at an opposite end thereof, the extendable portion comprising:
multiple tubular sections arranged in a nesting configuration such that the multiple tubular sections extend in a telescoping manner along a longitudinal axis between the first end of the stick and the second end of the stick from a retracted configuration to an extended configuration,
wherein each tubular section slidably engages at least one adjacent tubular section,
wherein each tubular section is releasably locked into place with at least one adjacent tubular section when the stick is in the extended configuration using a cooperating locking means between adjacent tubular sections for restraining movement of the tubular sections relative to one another when engaged.

2. The telescoping stick of claim 1, wherein the button-engagement tip is mechanically coupled to the ball-and-socket swivel by a connection.

3. The telescoping stick of claim 2, wherein the socket of the ball-and-socket swivel includes a notch to receive the connection at an angle approximately perpendicular to the stick.

4. The telescoping stick of claim 2, wherein the connection is a threaded connection.

5. The telescoping stick of claim 2, wherein the connection is a removable connection.

6. The telescoping stick of claim 1, wherein the button-engagement tip is interchangeable.

7. The telescoping stick of claim 1, wherein the button-engagement tip is made of rubber.

8. The telescoping stick of claim 1, wherein the button-engagement tip is made of silicone.

9. The telescoping stick of claim 1, wherein the button-engagement tip includes nubs for gripping the button.

10. The telescoping stick of claim 1, wherein the button-engagement tip is shaped to approximate the size and shape of a human finger.

11. The telescoping stick of claim 1, wherein the tubular sections are non-circular in cross-sectional shape.

12. The telescoping stick of claim 11, wherein the tubular sections are square in cross-sectional shape.

13. The telescoping stick of claim 1, wherein the stick is approximately seven feet long when in the fully extended configuration.

14. The telescoping stick of claim 1, wherein the stick is approximately three feet long when in the fully retracted configuration.

15. The telescoping stick of claim 1, wherein the cooperating locking means includes a retractable button and a corresponding aperture for the button.

16. The telescoping stick of claim 1, wherein each cooperating locking means is located proximate the end of a tubular section.
